(19) United States
(12) Patent Application Publication
(10) Pub. No.: US 2019/0350307 A1
(43) Pub. Date: Nov. 21, 2019

(54) METATARSAL GUARD FOR SAFETY FOOTWEAR AND METHOD FOR MANUFACTURING THE SAME

(71) Applicant: CHAUSSURES RÉGENCE INC., Québec (CA)

(72) Inventor: Christian Bergeron, Québec (CA)

(21) Appl. No.: 16/410,310

(22) Filed: May 13, 2019

Related U.S. Application Data
(60) Provisional application No. 62/671,621, filed on May 15, 2018.

(51) Int. Cl. A43B 7/32; B29D 35/00

(52) U.S. Cl. CPC A43B 7/32; B29K 2075/00; B29D 35/0009

(57) ABSTRACT

Safety footwear, a metatarsal guard for safety footwear, and a method for manufacturing a metatarsal guard comprising: a guard body sized and shaped to cover at least partially a dorsal surface of a wearer's foot, the guard body including: a shielding layer made of a rigid material, the shielding layer further including a first bonding surface; an extension panel extending forwardly from the guard body, the extension panel including a second bonding surface, the extension panel being disposed against the shielding body such that the first and second bonding surfaces are superposed over each other, the extension panel being overmolded over the shielding layer such that the extension panel is bonded with the shielding layer along the superposed first and second bonding surfaces.

### CROSS REFERENCE TO RELATED APPLICATIONS

This application claims priority to currently pending U.S. Provisional Application Ser. No. 62/671,621; filed on May 15, 2018, the specification of which is incorporated herein by reference.

### TECHNICAL FIELD

The technical field generally relates to safety footwear, and more specifically to metatarsal guards for safety footwear, to safety footwear and to methods for manufacturing metatarsal guards and safety footwear including metatarsal guards.

### BACKGROUND

Safety footwear, including safety boots, safety shoes and other types of safety footwear, is typically used by workers in locations where they could be exposed to hazards which may cause injury to the workers, and particularly to the feet of the workers.

Safety footwear are typically configured similarly to regular footwear, apart from one or more modifications destined to protect the wearer's foot received in the footwear. More specifically, safety footwear typically includes an outsole and an upper secured to the outsole and defining a foot receiving cavity, similarly to regular footwear.

Safety footwear may further include a toecap member, made of a relatively hard material such as steel, which is integrated to the upper at the front of the upper to protect the wearer's toes from injuries caused by falling objects such as constructions sites, manufacturing plants, mines and the like.

Some safety footwear may further include an internal metatarsal guard which is disposed in the foot receiving cavity and which is curved along the upper to cover a portion of the foot's dorsal surface, and specifically the foot's metatarsus located rearward of the toes and usually at least part of the foot's tarsus located rearward of the metatarsus. Most metatarsal guards even extend further forward to the toecap member and are connected to the toecap member.

Unfortunately, this type of metatarsal guard usually includes a number of distinct components and may require fasteners such as rivets or the like to assemble these components together, which makes the metatarsal guard relatively complex to manufacture.

Moreover, in some safety footwear which are made of an elastomer such as rubber or polyurethane, securing the metatarsal guard to the upper may prove relatively difficult.

There is therefore a need for a metatarsal guard and for safety footwear which will address at least one of the above-identified drawbacks.

### SUMMARY

According to one aspect, there is provided a metatarsal guard for safety footwear, the metatarsal guard comprising: a guard body sized and shaped to cover at least partially a dorsal surface of a wearer's foot, the guard body having a front end disposed towards a toe end of the safety footwear and a rear end opposite the toe end, the guard body including a shielding layer made of a rigid material, the shielding layer having a bottom surface adapted to be disposed towards the wearer's foot and a top surface adapted to be disposed away from the wearer's foot, the shielding layer further having a front end, a rear end and a first bonding surface extending rearwardly from the front end towards the rear end; and an extension panel extending forwardly from the front end of the guard body, the extension panel having a bottom surface adapted to be disposed towards the wearer's foot and a top surface adapted to be disposed away from the wearer's foot, the extension panel further having a front end, a rear end and a second bonding surface extending forwardly from the rear end towards the front end, the rear end of the extension panel overlapping the front end of the shielding body such that the first and second bonding surfaces are superposed over each other, the extension panel being overmolded over the shielding layer such that the extension panel is securely bonded with the shielding layer along the superposed first and second bonding surfaces to thereby form a fastenerless connection between the extension panel and the guard body.

In at least one embodiment, the shielding layer is made from a first polymer material and the extension panel is made from a second polymer material different from the first polymer material.

In at least one embodiment, the first polymer material has a first hardness and the second polymer material has a second hardness, the first hardness being greater than the second hardness.

In at least one embodiment, the first hardness of the first polymer is about 64 Shore D.

In at least one embodiment, the second hardness of the second polymer is about 60 Shore A.

In at least one embodiment, the extension panel is made from an elastomeric polymer material.

In at least one embodiment, the elastomeric polymer material includes thermoplastic polyurethane.

In at least one embodiment, the shielding layer is made from a rigid polymer material selected from a group consisting of: thermoplastic polyurethane and hard nylon.

In at least one embodiment, the top surface of the shielding layer is substantially continuous with the top surface of the extension panel and the bottom surface of the shielding layer is substantially continuous with the bottom surface of the extension panel.

In at least one embodiment, the shielding layer includes a first beveled portion located at the front end thereof and the extension panel includes a second beveled portion located at the rear end thereof, the first beveled portion having a first angled surface defining the first bonding surface and the second beveled portion having a second angled surface defining the second bonding surface, the first angled surface having a first bevel angle and the second angled surface having a second bevel angle substantially equal to the first bevel angle.

In at least one embodiment, the first beveled portion is defined on the bottom surface of the shielding layer and the second beveled portion is defined on the top surface of the extension panel.

In at least one embodiment, the shielding layer includes at least one interlock opening extending through the first bonding surface and the extension panel includes at least one anchor member extending away from the second bonding surface, each anchor member engaging a corresponding interlock opening to define a mechanical interlock connection between the extension panel and the shielding layer.

In at least one embodiment, the guard body includes a pair of longitudinal slits extending from the rear end of the guard body towards the front end and a pair of curved slits spaced inwardly from the longitudinal slits to define a pair of lateral tongues between the curved slits and the longitudinal slits, the curved slits being further spaced from each other to define a T-shaped tongue member therebetween.

In at least one embodiment, the guard body further includes a cushioning layer made of a resilient material, the cushioning layer being secured to the bottom surface of the shielding layer and overlapping the extension panel.

In at least one embodiment, the shielding layer has an outer edge and the cushioning layer extends outwardly beyond the outer edge of the shielding layer.

According to another aspect, there is also provided a method for manufacturing a metatarsal guard for safety footwear, the method comprising: providing a shielding layer made of a rigid material, the shielding layer having a bottom surface adapted to be disposed towards the wearer's foot and a top surface adapted to be disposed away from the wearer's foot, the shielding layer further having a front end, a rear end and a first bonding surface located at the front end; overmolding an extension panel over the shielding layer such that the extension panel extends forwardly of the shielding layer and a rear end of the extension panel overlaps the front end of the shielding layer, and such that the extension panel defines a second bonding surface located at the rear end of the extension panel and bonded with the first bonding surface.

In at least one embodiment, overmolding the extension panel comprises: positioning at least the front end of the shielding layer in an extension panel mold corresponding to a shape of the extension panel; providing at least partially melted molding material in the extension panel mold; curing the at least partially melted molding material received in the extension panel mold to thereby form the extension panel.

In at least one embodiment, providing at least partially melted molding material in the extension panel mold further comprises providing at least partially melted molding material in at least one interlock opening defined in the shielding layer near the front end of the shielding layer received in the extension panel mold, and further wherein curing the at least partially melted molding material further comprises curing the at least partially melted molding material received in the at least one interlock opening to thereby form, in each interlock opening, a corresponding anchor member extending from the extension panel.

In at least one embodiment, the method further comprises, after overmolding the extension panel: overmolding a cushioning layer over the bottom surface of the shielding layer and over the rear end of the extension panel.

In at least one embodiment, providing the shielding layer includes: providing at least partially melted molding material in a shielding layer mold corresponding to a shape of the extension panel; curing the at least partially melted molding material received in the shielding layer mold to thereby form the shielding layer.

According to yet another aspect, there is also provided safety footwear comprising: an outsole; an upper secured to the outsole, the upper having a curved sidewall extending above the outsole to define a foot receiving cavity between the upper and the outsole; a toecap member disposed in the foot receiving cavity at a toe end of the foot receiving cavity; a metatarsal guard including: a guard body located in the foot receiving cavity, the guard body being disposed against the upper and rearwardly of the toecap member, the guard body being sized and shaped so as to cover at least partially a dorsal surface of a wearer's foot when the wearer's foot is received in the foot receiving cavity, the guard body having a front end disposed towards a toe end of the safety footwear and a rear end opposite the toe end, the guard body including a shielding layer made of a rigid material, the shielding layer having a bottom surface adapted to be disposed towards the wearer's foot and a top surface adapted to be disposed away from the wearer's foot, the shielding layer further having a front end, a rear end and a first bonding surface extending rearwardly from the front end towards the rear end; and an extension panel extending from the front end of the guard body rearwardly towards the rear end, the extension panel having a bottom surface disposed towards the foot receiving cavity and a top surface disposed away from the foot receiving cavity, the extension panel further having a front end, a rear end and a second bonding surface extending forwardly from the rear end towards the front end, the rear end of the extension panel overlapping the front end of the shielding layer such that the first and second bonding surfaces are superposed over each other, the extension panel being overmolded over the shielding layer such that the extension panel is securely bonded with the shielding layer along the superposed first and second bonding surfaces to thereby form a fastenerless connection between the extension panel and the shielding layer.

In at least one embodiment, the guard body is positioned so as to cover a metatarsus and at least a portion of a tarsus of the wearer's foot when the wearer's foot is received in the foot receiving cavity.

In at least one embodiment, the safety footwear further comprises an inner lining layer located inside the foot receiving cavity and extending along the curved sidewall so as to be disposed between the upper and the wearer's foot when the wearer's foot is received in the foot receiving cavity, the metatarsal guard and the toecap member being disposed between the inner lining layer and the curved wall.

According to still another aspect, there is also provided safety footwear comprising: an outsole; an upper secured to the outsole, the upper having a curved sidewall defining a foot receiving cavity between the upper and the outsole for receiving a wearer's foot, the curved sidewall being made from a plastic polymer material; and a metatarsal guard encased within the curved sidewall, the metatarsal guard being located generally above the foot receiving cavity and being positioned so as to extend over a metatarsus and at least a portion of a tarsus of the wearer's foot when the wearer's foot is received in the foot receiving cavity.

In at least one embodiment, the metatarsal guard is planar and is substantially flexible to allow the metatarsal guard to be curved according to a curvature of the curved sidewall.

In at least one embodiment, the metatarsal guard is manufactured from a pre-fabricated sheet of thermoplastic material.

In at least one embodiment, the thermoplastic material is selected from a group consisting of: thermoplastic polyurethane (TPU), polyethylene terephthalate (PET), polyamide (PA) and nylon.

In at least one embodiment, the pre-fabricated sheet of thermoplastic material includes a fiber grid incorporated therein.

In at least one embodiment, the metatarsal guard includes an elongated band which extends generally transversely to the foot receiving cavity and a rectangular panel which extends forwardly from a center of the elongated band.

In at least one embodiment, the safety footwear further comprises a toecap member encased within the curved sidewall, the toecap member being positioned at a toe end of the foot receiving cavity, forwardly of the metatarsal guard, the rectangular panel extending at least partially over the toecap member.

In at least one embodiment, the metatarsal guard is substantially rigid and is curved according to a curvature of the curved sidewall.

In at least one embodiment, the metatarsal guard includes a central elongated portion extending generally transversely to the foot receiving cavity, a rear extension portion extending rearwardly from a center of the central elongated portion and a front extension portion extending forwardly from the center of the central elongated portion.

In at least one embodiment, the safety footwear further comprises a toecap member encased within the curved sidewall, the toecap member being positioned at a toe end of the foot receiving cavity, forwardly of the metatarsal guard, the front extension portion extending at least partially over the toecap member.

In at least one embodiment, the metatarsal guard further includes a plurality of interlock openings extending therethrough for promoting bonding between the metatarsal guard and the curved sidewall.

According to still yet another aspect, there is also provided a method for manufacturing safety footwear, the method comprising: providing a footwear mold of the safety footwear, the footwear mold including an inner mold portion for forming the foot receiving cavity, the inner mold portion being substantially foot-shaped; positioning a metatarsal guard within the footwear mold at a predetermined position corresponding to a position of the metatarsus on the foot-shaped inner portion of the mold; providing at least partially melted material in the footwear mold; curing the at least partially melted material to form the safety footwear having a curved sidewall defining a foot receiving cavity between the upper and the outsole, with the metatarsal guard being encased in the curved sidewall.

In at least one embodiment, providing at least partially melted material in the footwear mold comprises injecting at least partially melted material in the footwear mold.

In at least one embodiment, the method further comprises, after providing the footwear mold of the safety footwear, placing an inner lining sock on the inner mold portion of the footwear mold.

In at least one embodiment, the method further comprises, after providing the mold of the safety footwear, positioning a toecap member within the footwear mold at a toe end of the foot receiving cavity.

In at least one embodiment, the method further comprises, before positioning the metatarsal guard within the footwear mold, cutting a pre-fabricated sheet of molded thermoplastic material to form the metatarsal guard.

In at least one embodiment, the method further comprises, before positioning the metatarsal guard within the footwear mold, molding the metatarsal guard using a corresponding metatarsal guard mold and a rigid thermoplastic material.

### BRIEF DESCRIPTION OF THE DRAWINGS

FIG. 1 is a cross-sectional side view of safety footwear including a toecap member and a metatarsal guard, in accordance with one embodiment;

FIG. 2 is an enlarged view of the safety footwear illustrated in FIG. 1, taken from area 2 of FIG. 1;

FIG. 3 is a perspective view of the metatarsal guard illustrated in FIG. 1;

FIG. 4 is a top plan view of the metatarsal guard illustrated in FIG. 1;

FIG. 5 is a bottom plan view of the metatarsal guard illustrated in FIG. 1;

FIG. 6 is another bottom plan view of the metatarsal guard illustrated in FIG. 1, with the cushioning layer removed to show the interface between the guard body and the extension panel;

FIG. 7 is another bottom plan view of the metatarsal guard with the cushioning layer removed as illustrated in FIG. 6;

FIG. 8 is a cross-sectional side view of safety footwear including a metatarsal guard, in accordance with another embodiment;

FIG. 9 is a top plan view of the metatarsal illustrated in FIG. 8;

FIG. 10 is a perspective view of a metatarsal guard for safety footwear, in accordance with yet another embodiment; and

FIG. 11 is a top plan view of the metatarsal guard illustrated in FIG. 10.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

For the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Moreover, it will be appreciated that positional descriptions such as “above”, “below”, “top”, “bottom”, “forward”, “rearward” “left”, “right” and the like should, unless otherwise indicated, be taken in the context of the figures and correspond to the position and orientation in the safety footwear and/or metatarsal guard and corresponding parts when being used. Positional descriptions should not be considered limiting.

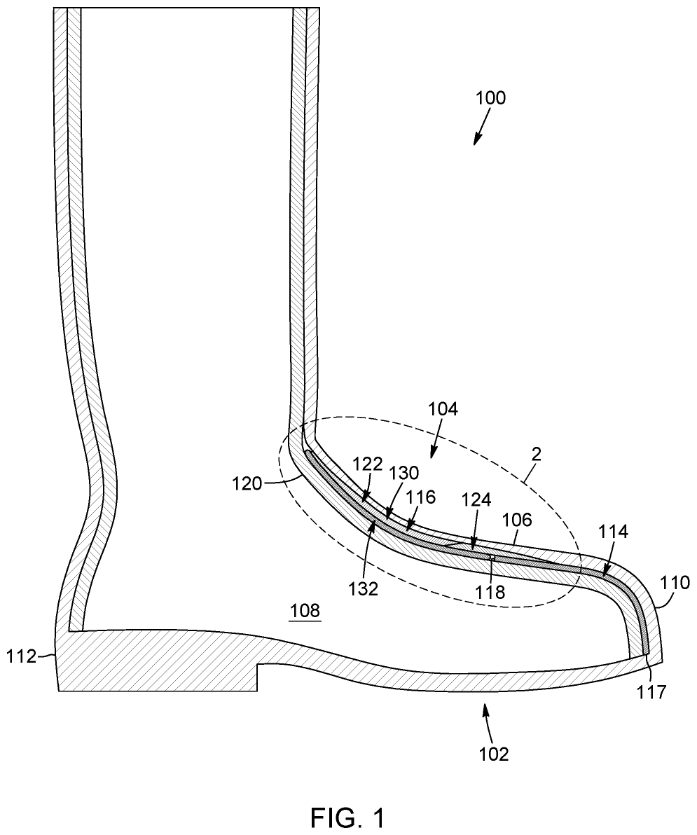

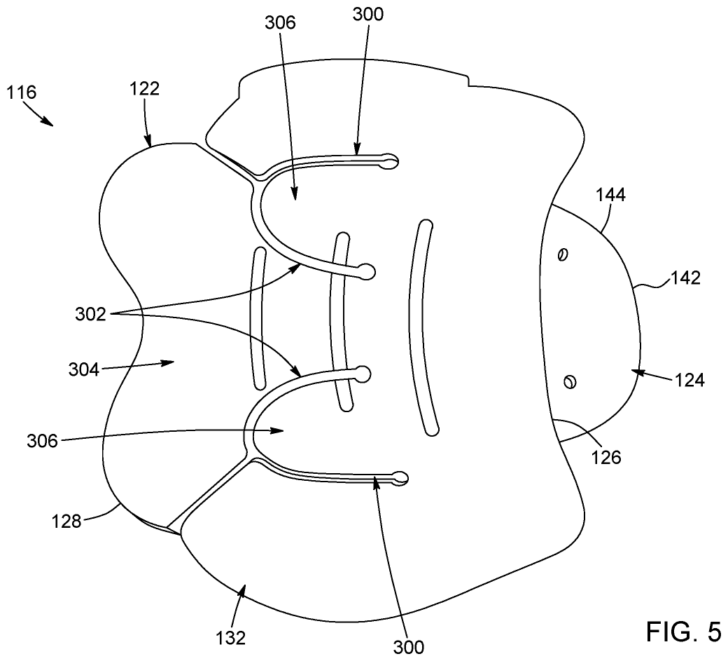

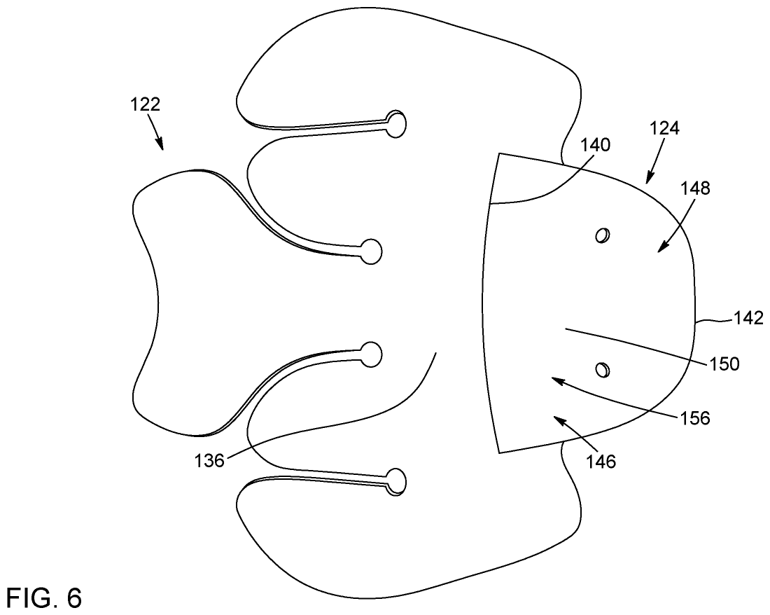

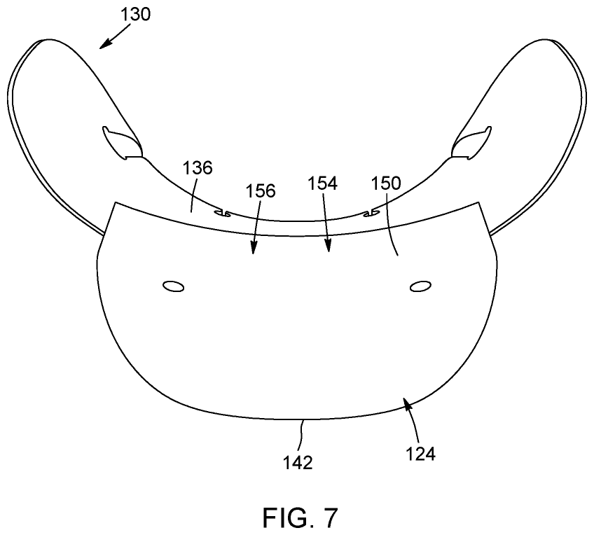

Referring first to FIGS. 1 to 7, there is shown safety footwear 100, in accordance with one embodiment. The safety footwear 100 includes an outsole 102 and an upper 104 extending upwardly from the outsole 102. More specifically, the upper 104 includes a curved sidewall 106 which defines, above the outsole 102, a foot receiving cavity 108 sized and shaped to receive a foot of a wearer. The foot receiving cavity 108 is sized and shaped such that when the wearer's foot is received in the foot receiving cavity 108, the wearer's toes are located at a first or toe end 110 of the safety footwear 100 and the wearer's heel is located an opposite second or heel end 112 of the safety footwear 100.

In the illustrated embodiment, the safety footwear 100 further includes a toecap member 114 and a metatarsal guard 116. The toecap member 114 is generally dome-shaped and includes a front end 117 located at the toe end 110 of the safety footwear 100 and a rear end 118 located rearwardly of the toe end 110, towards the heel end 112 of the safety footwear 100. Specifically, the rear end 118 of the toecap member 114 is sufficiently spaced rearwardly from the front end 117 of the toecap member 114 to allow the toecap member 114 to substantially cover the toes of the wearer's foot when the wearer's foot is received in the foot receiving cavity 108.

The toecap member 114 is manufactured from a rigid and relatively hard material such as steel to protect the wearer's toe from falling objects or similar downward impact when the wearer's foot is received in the foot receiving cavity 108.

Still referring to FIGS. 1 to 7, the metatarsal guard 116 is also disposed generally above the foot receiving cavity 108 and is disposed rearwardly of the toecap member 114 to generally cover the metatarsus and at least a portion of the tarsus of the wearer's foot when the wearer's foot is received in the foot receiving cavity 108. It will be understood that reference to the wearer's foot being received in the foot receiving cavity 108 in the description below may include the wearer's foot covered by a sock worn by the wearer over his or her foot.

As best shown in FIG. 1, the metatarsal guard 116 is disposed within the foot receiving cavity 108 and extends along the curved sidewall 106 of the upper 104 above the foot receiving cavity 108. The safety footwear 100 further includes an inner sock or lining layer 120 which extends inside the foot receiving cavity 108 along the curved sidewall 106 and which is adapted to contact the wearer's foot when the wearer's foot is received in the foot receiving cavity 108. In this embodiment, the toecap member 114 and the metatarsal guard 116 may be disposed between the upper 104 and the inner lining layer 120.

In the embodiment illustrated in FIGS. 1 to 7, the metatarsal guard 116 includes a guard body 122 and an extension panel 124 extending frontwardly from the guard body 122. The guard body 122 has a front end 126 adapted to be disposed towards the toe end 110 of the safety footwear 100 and a rear end 128 adapted to be disposed towards the heel end 112.

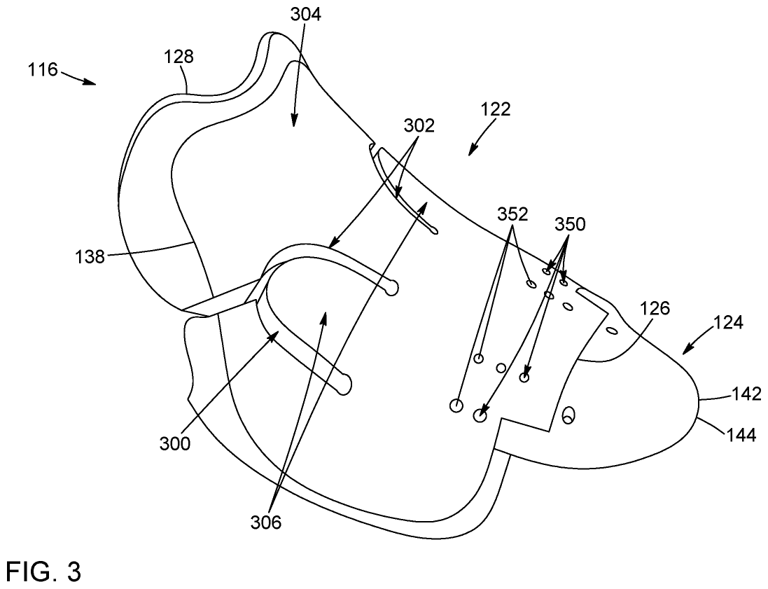

As best shown in FIGS. 3 to 7, the guard body 122 is substantially curved so as to generally follow a corresponding curvature of a dorsal surface of the wearer's foot.

Moreover, in the embodiment illustrated in FIGS. 1 to 7, the guard body 122 is generally configured to be relatively deformable for the comfort of the wearer during walking or other foot movements, while allowing impacts on the guard body 122 to be distributed across the entire guard body 122.

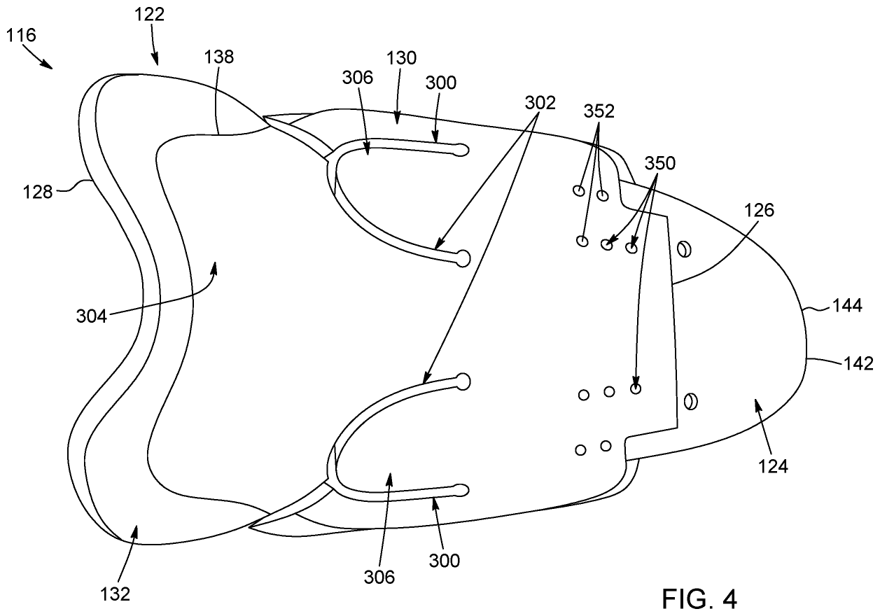

For example, the guard body 122 could be generally shaped similarly to the metatarsal guard disclosed in U.S. Pat. No. 6,161,313, the specification of which is incorporated herein by reference. As best shown in FIGS. 3 and 4, the guard body 122 includes a pair of longitudinal slits 300 extending from the rear end 128 of the guard body 122 towards the front end 126 and a pair of curved slits 302 spaced inwardly from the longitudinal slits 300. In this configuration, the curved slits 302 are spaced from each other to define a generally T-shaped tongue member 304 between the curved slits 302, and a pair of lateral tongues 306 are defined between the curved slits 302 and the longitudinal slits 300. This arrangement allows the guard body 122 to flex during walking and kneeling, while simultaneously ensuring efficient distribution of a load or impact applied to the guard body 122.

Alternatively, the guard body 122, including the slits 300, 302, could have any other shape and configuration which a skilled person would consider to be appropriate.

In the embodiment illustrated in FIGS. 1 to 7, the guard body 122 further includes a shielding layer 130 made of a rigid material and a cushioning layer 132 made of a resilient material. Specifically, the shielding layer 130 includes a top surface 134 and a bottom surface 136, and the cushioning layer 132 is bonded to the bottom surface 136 of the shielding layer 130. When the metatarsal guard 116 is received in the foot receiving cavity 108, the guard body 122 is disposed such that the shielding layer 130 faces upwardly and the cushioning layer 132 faces downwardly so as to be oriented towards the wearer's foot when the wearer's foot is received in the foot receiving cavity 108. It will be understood that in this configuration, the shielding layer 130 allows loads or impacts to be distributed across a certain surface area, while the cushioning layer 132 further contributes to absorbing the load or impact on the shielding layer 130.

Still in the embodiment illustrated in FIGS. 1 to 7, the shielding layer 130 has an outer edge 138 which delimits peripherally the shielding layer 130 and the cushioning layer 132 extends outwardly beyond the outer edge 138 of the shielding layer 130. This configuration prevents the outer edge 138 of the rigid shielding layer 130 from contacting and/or digging into the wearer's foot when the wearer's foot is received in the foot receiving cavity 108, which may cause discomfort to the wearer.

Still referring to FIGS. 1 to 7, the extension panel 124 has a rear end 140 connected to the guard body 122 and a front end 142 disposed away from the guard body 122. Specifically, the extension panel 124 includes a front arcuate edge 144 located at the front end 142 of the extension panel 124 and which curves forwardly away from the guard body 122. The extension panel 124 further includes a rear portion 146 which overlaps the guard body 122 and a front portion 148 which is located forward of the guard body 122.

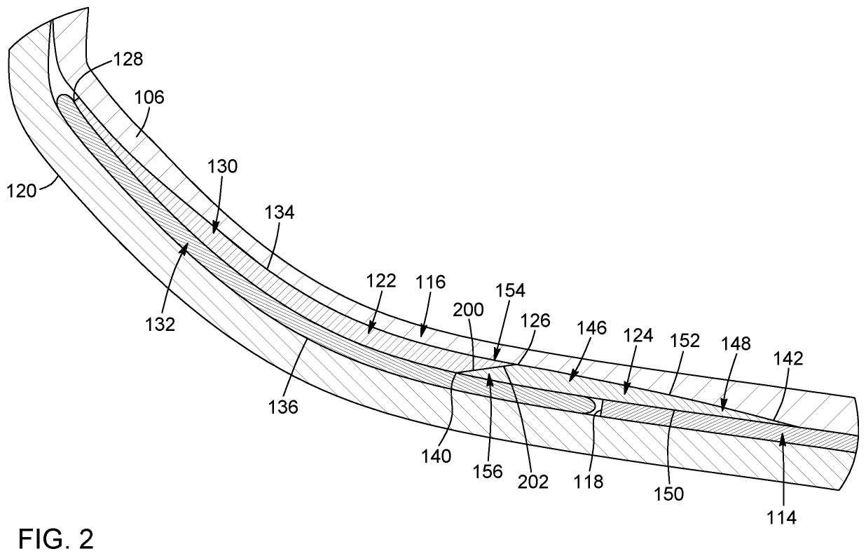

In the embodiment illustrated in FIGS. 1 to 7, the extension panel 124 extends forward of the guard body 122 such that it overlaps at least partially the toecap member 114 disposed forward of the metatarsal guard 116. Specifically, as best shown in FIGS. 1 and 2, the front end 142 of the extension panel 124 is located forward of the rear end 118 of the toecap member 114, between the rear end 118 of the toecap member 114 and the front end 117 of the toecap member 114. The front end 142 of the extension panel 124 is therefore disposed between the toecap member 114 and the curved sidewall 106 of the upper 104. This configuration allows a load or impact on the guard body 122 to be further distributed on the toecap member 114 as well.

In one embodiment, the extension panel 124 simply rests on the toecap member 114. Alternatively, the extension panel 124 could be secured to the toecap member 114 by gluing, using fasteners extending through the extension panel 124 and the toecap member 114, or using any other securing technique which a skilled person would consider to be appropriate.

In the embodiment illustrated in FIGS. 1 to 7, the extension panel 124 is secured to the guard body 122 such that it forms a substantially smooth and seamless extension of the guard body 122. Specifically, the extension panel 124 includes a bottom surface 150 which faces towards the wearer's foot and a top surface 152 which faces away from the wearer's foot when the wearer's foot is received in the foot receiving cavity 108. The extension panel 124 further includes a first beveled portion 154 defined on the top surface 152 and extending from the front end 142 towards the rear end 140.

The shielding layer 130 of the guard body 122 includes a corresponding beveled portion 156 defined on the bottom surface 136 of the shielding layer 130 and extending from the front end 126 of the guard body 122 rearwardly towards the rear end 128. The first beveled portion 154 and the second beveled portion 156 are further generally complementary to each other such that the extension panel 124 and the shielding layer 130 may together define a substantially continuous body.

As best shown in FIG. 2, the first beveled portion 154 includes an angled top bonding surface 200 which is angled at a first bevel angle relative to the bottom surface 150 of the extension panel 124 and the second beveled portion 156 includes an angled bottom bonding surface 202 which is angled at a second bevel angle relative to the top surface 134 of the shielding body 130. The first and second bevel angles are substantially similar to each other such that when the second beveled portion 156 is superposed over the first beveled portion 154, the top surface 134 of the shielding layer 130 is disposed substantially flush with the top surface 152 of the extension panel 124 and the bottom surface 136 of the shielding layer 130 is disposed substantially flush with the bottom surface 150 of the extension panel 124.

To achieve the configuration described above, the extension panel 124 may be overmolded over the shielding layer 130 to define a fastenerless and substantially seamless connection between the extension panel 124 and the shielding layer 130. In other words, the extension panel 124 is bonded to the shielding layer 130 along their superposed bonding surfaces 200, 202.

Specifically, the shielding layer 130 or at least the second beveled portion 156 of the shielding layer 130 may be positioned in a mold corresponding to the shape of the extension panel 124. Molding material which is at least partially melted may then be provided or injected into the mold and then cured to form the extension panel 124. During the overmolding of the extension panel 124, bonds may be formed at least superficially between the extension panel 124 and the shielding layer 130, thereby securing the extension panel 124 to the shielding layer 130 without requiring the use of fasteners.

In one embodiment, the shielding layer 130 and the extension panel 124 may be manufactured using material which promotes such bonds between the extension panel 124 and the shielding layer 130.

For example, the shielding layer 130 may be manufactured using a thermoplastic material selected from a group consisting of: thermoplastic polyurethane (TPU) and hard nylon. Alternatively, the shielding layer 130 may be manufactured using another moldable material which a skilled person would consider to be suitable to provide adequate bonding with the extension panel 124 and with the cushioning layer 132.

In one embodiment, the extension panel 124 may be manufactured from a different material than the shielding layer 130, such that the extension panel 124 is relatively more flexible than the shielding layer 130. For example, the shielding layer 130 may have a Shore durometer or hardness value of about 64 D (or a hardness of about 64 Shore D) and the extension panel may have a Shore durometer or hardness value of about 60 A (or a hardness of about 60 Shore A). Since the extension panel 124 is more flexible than the shielding layer 130, a hinge is defined between the extension panel 124 and the shielding layer 130 such that the extension panel 124 can flex or pivot with respect to the shielding layer 130.

In one embodiment, the extension panel 124 may be manufactured using an elastomeric material such as thermoplastic polyurethane (TPU). Alternatively, the extension panel 124 may be manufactured using another moldable material which a skilled person would consider to be suitable to provide adequate bonding with the shielding layer 130 and the cushioning layer 132.

To further promote a secure connection between the extension panel 124 and the guard body 122, the guard body 122 may further include a plurality of interlock openings 350 extending through the shielding layer 130 near the front end of the guard body 122. When the moldable material is injected into the mold, a portion of the moldable material flows into the interlock openings 350 and, when solidified, define a plurality of anchor members 352 extending away from the second bonding surface 202. Specifically, each anchor member 352 engages a corresponding interlock opening 350 to define a mechanical interlock connection between the extension panel 124 and the shielding layer 130 to further secure the extension panel 124 to the shielding layer 130.

In the embodiment illustrated in FIGS. 2 to 7, the cushioning layer 132 extends over the first beveled portion 154 of the extension panel 124 as well as the bottom surface 136 of the shielding layer 130, such that the first beveled portion 154 of the extension panel 124 is substantially sandwiched between the second beveled portion 156 of the shielding layer 130 and the cushioning layer 132.

During the manufacturing of the metatarsal guard 116, once the extension panel 124 has been overmolded over the shielding layer 130, the cushioning layer 132 may further be overmolded over the bottom surface 136 of the shielding layer 130 and the first beveled portion 154 of the extension panel 124. In this operation, bonds may be formed at least superficially between the cushioning layer 132 and the shielding layer 130 and between the cushioning layer 132 and the extension panel 124 to thereby secure the cushioning layer to the cushioning layer 132 to the shielding body 130 and the extension panel 124.

Alternatively, the cushioning layer 132 may be formed separately from the shielding layer 130 and the extension panel 124 and further secured to the shielding layer 130 and the extension panel 124 by gluing or using another appropriate technique in a separate operation.

In one embodiment, the cushioning layer 132 may be manufactured using a resilient material such as polyurethane. Alternatively, the cushioning layer 132 may be manufactured using another resilient or shock-absorbing material which a skilled person would consider to be suitable to provide adequate bonding with the shielding layer 130 and the extension panel 124.

It will be understood that the safety footwear 100 is only described as including a toecap member 114 and a metatarsal guard 116, the safety footwear 100 could further include additional safety features such as a puncture-resistant insole and the like.

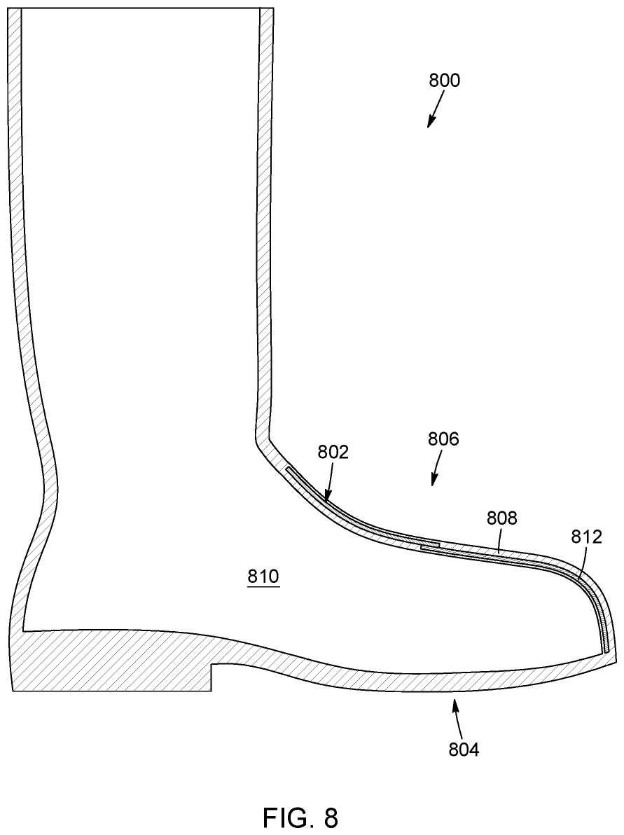

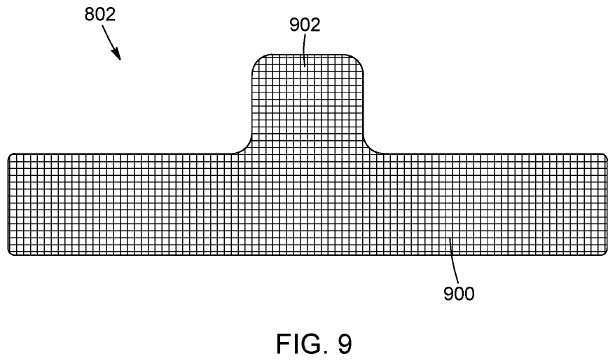

Turning now to FIGS. 8 and 9, there is shown safety footwear 800 including a metatarsal guard 802, in accordance with another embodiment.

In this embodiment, the safety footwear 800 is manufactured by molding, and more specifically by injection molding, using a plastic polymer material such as polyurethane (PU), ethylene-vinyl acetate (EVA), thermoplastic polyurethane (TPU), thermoplastic rubber (TPR), polyvinyl chloride (PVC) or any other plastic polymer material which a skilled addressee would consider to be appropriate.

Similarly to the safety footwear 100, the safety footwear 800 includes an outsole 804 and an upper 806 secured to the outsole 804. More specifically, the upper 806 includes a curved sidewall 808 which defines above the outsole 804 a foot receiving cavity 810 sized and shaped to receive a foot of a wearer. In the illustrated embodiment, the safety footwear 800 further includes a toecap member 812, generally similar to the toecap member 114 described above.

Still in the embodiment illustrated in FIGS. 8 and 9, the metatarsal guard 802 is located generally above the foot receiving cavity 810 and positioned such that it extends over the metatarsus and at least a portion of the tarsus of the wearer's foot when the wearer's foot is received in the foot receiving cavity 810. As shown in FIG. 8, the metatarsal guard 802 further extends partially over the toecap member 812.

As shown in FIG. 9, the metatarsal guard 802 is generally T-shaped and includes an elongated band 900 which extends generally transversely to the foot receiving cavity 810 and a rectangular panel 902 which extends forwardly from a center of the elongated band 900. It will be appreciated that the shape and the configuration of the metatarsal guard 802 can vary from the embodiment shown.

In the embodiment illustrated in FIGS. 8 and 9, the metatarsal guard 802 is initially generally planar but is substantially flexible such that it may curve along the curved sidewall 808 to follow an outline of the foot receiving cavity 810. In one embodiment, the metatarsal guard 802 is manufactured from a thermoplastic material including thermoplastic polyurethane (TPU), polyethylene terephthalate (PET), polyamide (PA) and/or nylon. More specifically, the metatarsal guard 802 may have a Shore durometer hardness value of 98 A and may include 25% of nylon. Alternatively, the metatarsal guard 802 may be manufactured using any other material which a skilled person would consider to be suitable to provide adequate bonding with the curved sidewall 808.

In one embodiment, the metatarsal guard 802 is cut from a pre-fabricated sheet of molded thermoplastic material. Alternatively, the metatarsal guard 802 could be directly molded into its desired shape using an appropriately shaped mold.

In one embodiment, the thermoplastic material used to manufacture the metatarsal guard 802 can be fiber-reinforced. Specifically, a fiber grid could be incorporated inside the pre-fabricated sheet of thermoplastic material.

Still in the embodiment illustrated in FIGS. 8 and 9, the metatarsal guard 802 has a thickness of about 0.5 mm to 3 mm. Alternatively, the metatarsal guard 802 may have any other thickness which a skilled person would consider to be appropriate.

In this embodiment, the metatarsal guard 802 is integrated into the curved sidewall 808 of the upper 806. Specifically, the metatarsal guard 802 is molded into the upper 806 as the upper 806 is being manufactured.

To manufacture the safety footwear 800, a mold of the safety footwear 800 may first be provided. An inner sock or lining layer defining an outline of the foot receiving cavity 810 may be placed around an inner portion of the mold which is shaped as a foot for forming the foot receiving cavity 810 of the safety footwear 800.

The metatarsal guard 802 may be positioned at a desired position inside the mold, over the inner lining layer, generally corresponding to a position of the metatarsus on the foot-shaped inner portion of the mold. The metatarsal guard 802 is further positioned such that the rectangular panel 902 extends at least partially over the toecap member 812. The metatarsal guard 802 may be held in place in the desired position inside the mold using glue, tape, wire or another similar holding means.

Molding material may then be injected in the mold and the molding material may be cured such that the upper 806 may be formed with the metatarsal guard 802 encased within the upper's curved sidewall 808.

It will be appreciated that manufacturing the safety footwear 800 according to the method described above minimizes the manufacturing steps required to integrate the metatarsal guard 802 to the safety footwear 800, as well as preventing the metatarsal guard 802 from becoming undesirably unsecured from the upper 806. Moreover, this method also allows the safety footwear 800 to be manufactured according to a configuration in which the interior surface of the upper 806 is relatively smooth and continuous, and thereby comfortable to the wearer's foot when the wearer's foot is received in the foot receiving cavity 810.

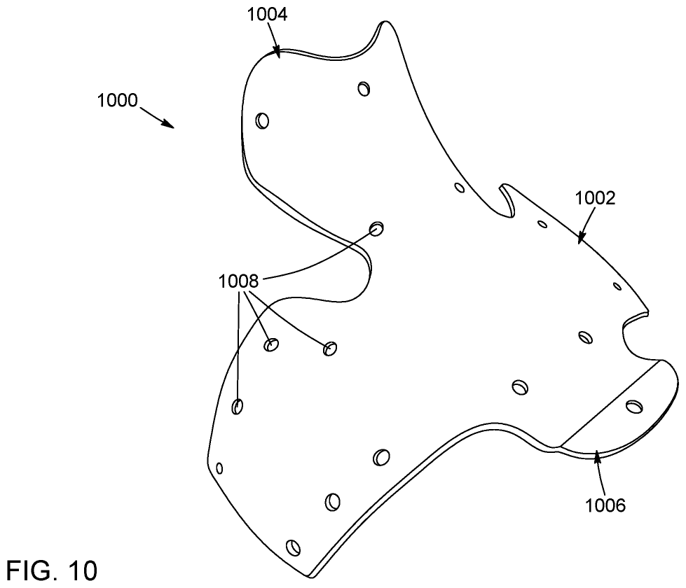

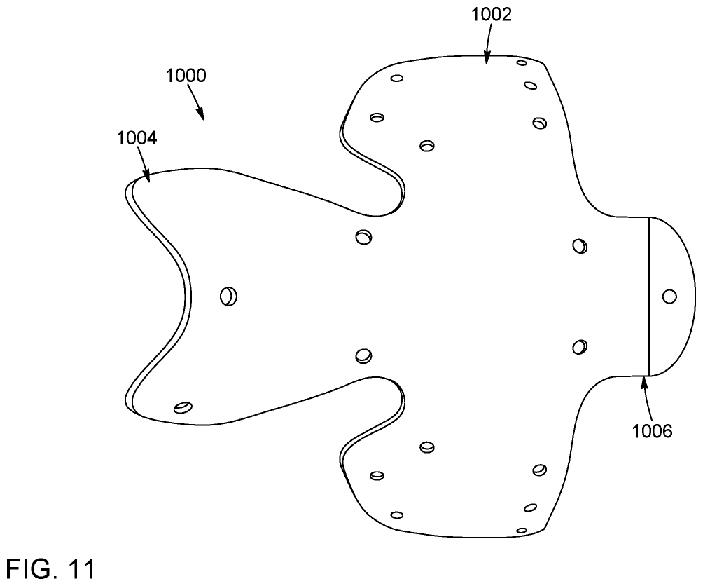

Referring now to FIGS. 10 and 11, there is shown a metatarsal guard 1000 for the safety footwear 800 illustrated in FIG. 8, in accordance with yet another embodiment.

In the embodiment illustrated in FIGS. 10 and 11, the metatarsal guard 1000 is substantially rigid. Specifically, the metatarsal guard 1000 may be made of a rigid material such as thermoplastic polyurethane. Alternatively, the metatarsal guard 1000 may be made of any other rigid material which a skilled person would consider to be appropriate to provide adequate bonding with the curved sidewall 808.

In the embodiment illustrated in FIGS. 10 and 11, the metatarsal guard 1000 is substantially curved so as to generally follow a corresponding curvature of the upper 806. The metatarsal guard 1000 includes a central elongated portion 1002 which extends generally transversely to the foot receiving cavity 810, a rear extension portion 1004 which extends rearwardly from a center of the central elongated portion 1002 and a front extension portion 1006 which extends forwardly from the center of the central elongated portion 1002. The central elongated portion 1002 is adapted to generally cover the metatarsus of the wearer's foot when the wearer's foot is received in the foot receiving cavity 810, the rear extension portion 1004 is adapted to cover at least partially the tarsus of the wearer's foot when the wearer's foot is received in the foot receiving cavity 810, and the front extension portion 1006 is adapted to extend at least partially over the toecap member 812 of the safety footwear 800.

The metatarsal guard 1000 is further integrated to the upper 806 of the safety footwear 800 using the same method as described above in connection with FIGS. 8 and 9. Specifically, a footwear mold of the safety footwear 800 is provided, the metatarsal guard 1000 is held in the mold at a desired position and molding material injected or otherwise provided in the mold and further cured to form the safety footwear 800 with the metatarsal guard 1000 encased in the safety footwear's curved sidewall 808.

In the embodiment illustrated in FIGS. 10 and 11, the metatarsal guard 1000 further includes a plurality of interlock openings 1008 which are adapted to allow moldable material to flow through during the molding of the upper 806. When solidified, the moldable material in the interlock openings 1008 forms a plurality of anchor points between the metatarsal guard 1000 and the curved sidewall 808, which further promotes secure bonding between the metatarsal guard 1000 and the curved sidewall 808.

It will be appreciated that in the embodiment illustrated in FIGS. 8 and 9 and in the embodiment illustrated in FIGS. 10 and 11, the thickness of the upper's curved sidewall 808 could be selected such that the metatarsal guard member 802 or 1000 is fully enclosed within the curved sidewall 808. For example, the curved sidewall 808 of the safety footwear 800 including the metatarsal guard 1000 illustrated in FIGS. 10 and 11 could be substantially thicker than the curved sidewall of the safety footwear including the metatarsal guard 802 illustrated in FIGS. 8 and 9 to accommodate the three-dimensional shape and features of the metatarsal guard 1000.

The method for manufacturing a safety footwear including the metatarsal guard member 1000 is similar to the one described hereinabove to include the metatarsal guard member 802 since the metatarsal guard member 1000 is at least partially contained in and covered by the thermoplastic forming the footwear shell.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A metatarsal guard for safety footwear, the metatarsal guard comprising:
a guard body sized and shaped to cover at least partially a dorsal surface of a wearer's foot, the guard body having a front end disposed towards a toe end of the safety footwear and a rear end opposite the toe end, the guard body including:
a shielding layer made of a rigid material, the shielding layer extending from the rear end of the guard body towards the front end, the shielding layer having a bottom surface adapted to be disposed towards the wearer's foot and a top surface adapted to be disposed away from the wearer's foot, the shielding layer further having a front end, a rear end and a first bonding surface extending rearwardly from the front end towards the rear end; and
an extension panel extending from the front end of the guard body rearwardly towards the rear end, the extension panel having a bottom surface adapted to be disposed towards the wearer's foot and a top surface adapted to be disposed away from the wearer's foot, the extension panel further having a front end, a rear end and a second bonding surface extending forwardly from the rear end towards the front end, the rear end of the extension panel overlapping the front end of the shielding body such that the first and second bonding surfaces are superposed over each other, the extension panel being overmolded over the shielding layer such that the extension panel is securely bonded with the shielding layer along the superposed first and second bonding surfaces.

2. The metatarsal guard as claimed in claim 1, wherein the shielding layer is made from a first polymer material and the extension panel is made from a second polymer material different from the first polymer material.

3. The metatarsal guard as claimed in claim 2, wherein the first polymer material has a first hardness and the second polymer material has a second hardness, the first hardness being greater than the second hardness.

4. The metatarsal guard as claimed in claim 3, wherein the first hardness of the first polymer is about 64 Shore D.

5. The metatarsal guard as claimed in claim 3, wherein the second hardness of the second polymer is about 60 Shore A.

6. The metatarsal guard as claimed in claim 1, wherein the extension panel is made from an elastomeric polymer material.

7. The metatarsal guard as claimed in claim 6, wherein the elastomeric polymer material includes thermoplastic polyurethane.

8. The metatarsal guard as claimed in claim 1, wherein the shielding layer is made from a rigid polymer material selected from a group consisting of: thermoplastic polyurethane and hard nylon.

9. The metatarsal guard as claimed in claim 1, wherein the top surface of the shielding layer is substantially continuous with the top surface of the extension panel and the bottom surface of the shielding layer is substantially continuous with the bottom surface of the extension panel.

10. The metatarsal guard as claimed in claim 9, wherein the shielding layer includes a first beveled portion located at the front end thereof and the extension panel includes a second beveled portion located at the rear end thereof, the first beveled portion having a first angled surface defining the first bonding surface and the second beveled portion having a second angled surface defining the second bonding surface, the first angled surface having a first bevel angle and the second angled surface having a second bevel angle substantially equal to the first bevel angle.

11. The metatarsal guard as claimed in claim 10, wherein the first beveled portion is defined on the bottom surface of the shielding layer and the second beveled portion is defined on the top surface of the extension panel.

12. The metatarsal guard as claimed in claim 1, wherein the shielding layer includes at least one interlock opening extending through the first bonding surface and the extension panel includes at least one anchor member extending away from the second bonding surface, each anchor member engaging a corresponding interlock opening to define a mechanical interlock connection between the extension panel and the shielding layer.

13. The metatarsal guard as claimed in claim 1, wherein the guard body includes a pair of longitudinal slits extending from the rear end of the guard body towards the front end and a pair of curved slits spaced inwardly from the longitudinal slits to define a pair of lateral tongues between the curved slits and the longitudinal slits, the curved slits being further spaced from each other to define a T-shaped tongue member therebetween.

14. The metatarsal guard as claimed in claim 1, wherein the guard body further includes a cushioning layer made of a resilient material, the cushioning layer being secured to the bottom surface of the shielding layer and overlapping the extension panel.

15. The metatarsal guard as claimed in claim 1, wherein the shielding layer has an outer edge and the cushioning layer extends outwardly beyond the outer edge of the shielding layer.

16. A method for manufacturing a metatarsal guard for safety footwear, the method comprising:
providing a shielding layer made of a rigid material, the shielding layer having a bottom surface adapted to be disposed towards the wearer's foot and a top surface adapted to be disposed away from the wearer's foot, the shielding layer further having a front end, a rear end and a first bonding surface located at the front end;
overmolding an extension panel over the shielding layer such that the extension panel extends forwardly of the shielding layer and a rear end of the extension panel overlaps the front end of the shielding layer, and such that the extension panel defines a second bonding surface located at the rear end of the extension panel and bonded with the first bonding surface.

17. The method as claimed in claim 16, wherein overmolding the extension panel comprises:
positioning at least the front end of the shielding layer in an extension panel mold corresponding to a shape of the extension panel;
providing at least partially melted molding material in the extension panel mold;
curing the at least partially melted molding material received in the extension panel mold to thereby form the extension panel.

18. The method as claimed in claim 17, wherein providing at least partially melted molding material in the extension panel mold further comprises providing at least partially melted molding material in at least one interlock opening defined in the shielding layer near the front end of the shielding layer received in the extension panel mold, and further wherein curing the at least partially melted molding material further comprises curing the at least partially melted molding material received in the at least one interlock opening to thereby form, in each interlock opening, a corresponding anchor member extending from the extension panel.

19. The method as claimed in claim 16, further comprising, after overmolding the extension panel:
overmolding a cushioning layer over the bottom surface of the shielding layer and over the rear end of the extension panel.

20. The method as claimed in claim 16, wherein providing the shielding layer includes:
providing at least partially melted molding material in a shielding layer mold corresponding to a shape of the extension panel;
curing the at least partially melted molding material received in the shielding layer mold to thereby form the shielding layer.

21. Safety footwear comprising:
an outsole;
an upper secured to the outsole, the upper having a curved sidewall extending above the outsole to define a foot receiving cavity between the upper and the outsole;
a toecap member disposed in the foot receiving cavity at a toe end of the foot receiving cavity;
a metatarsal guard including:
a guard body located in the foot receiving cavity, the guard body being disposed against the upper and rearwardly of the toecap member, the guard body being sized and shaped so as to cover at least partially a dorsal surface of a wearer's foot when the wearer's foot is received in the foot receiving cavity, the guard body having a front end disposed towards a toe end of the safety footwear and a rear end opposite the toe end, the guard body including:
a shielding layer made of a rigid material, the shielding layer having a bottom surface adapted to be disposed towards the wearer's foot and a top surface adapted to be disposed away from the wearer's foot;
a cushioning layer made of a resilient material, the cushioning layer being secured to the bottom surface of the shielding layer;
an extension panel extending forwardly from the guard body and at least partially over the toecap member, the shielding layer being partially superposed over a rear portion of the extension panel, the rear portion being overmolded over the shielding layer to form a fastenerless connection between the extension panel and the shielding layer.

22. The safety footwear as claimed in claim 21, wherein the guard body is positioned so as to cover a metatarsus and at least a portion of a tarsus of the wearer's foot when the wearer's foot is received in the foot receiving cavity.

23. The safety footwear as claimed in claim 21, further comprising an inner lining layer located inside the foot receiving cavity and extending along the curved sidewall so as to be disposed between the upper and the wearer's foot when the wearer's foot is received in the foot receiving cavity, the metatarsal guard and the toecap member being disposed between the inner lining layer and the curved wall.
